(19) United States
(12) Patent Application Publication
(10) Pub. No.: US 2014/0191425 A1
(43) Pub. Date: Jul. 10, 2014

(54) SYSTEM AND METHOD FOR GENERATING NANOBUBBLES

(71) Applicant: PANASONIC CORPORATION, Osaka (JP)

(72) Inventors: Hiroshi Yano, Osaka (JP); Ayumi Sakai, Osaka (JP)

(73) Assignee: PANASONIC CORPORATION, Osaka (JP)

(21) Appl. No.: 14/240,037

(22) PCT Filed: Dec. 3, 2012
(86) PCT No.: PCT/JP2012/007723

§ 371 Date: Feb. 21, 2014

(30) Foreign Application Priority Data
Dec. 16, 2011 (JP) 2011-275698

(51) Int. Cl. B01F 3/04

(52) U.S. Cl. CPC B01F 3/04113
USPC 261/124

(57) ABSTRACT

Provided is a nanobubble generating system and a nanobubble generating method in which nanobubbles exist stably in a liquid phase by a very simple constitution and a very simple process. A nanobubble generating system has a generation chamber for accommodating a gas phase part existing in the upper side and a liquid phase part in contact with the lower side of the gas phase part under sealed condition, a supersaturated dissolved liquid generating device for generating supersaturated dissolved liquid in which a gas is dissolved in the liquid phase part under supersaturated condition, and a nanobubble generating device for feeding a pressurized gas to said supersaturated dissolved liquid via through-holes having a nano-sized opening size to generate nanobubbles having a diameter smaller than 1 μm.

### TECHNICAL FIELD

The present invention relates to a nanobubble generating system and a nanobubble generating method.

### BACKGROUND ART

Conventionally, liquid containing nanobubbles, that is, bubbles having a diameter smaller than 1 μm (1000 nm) (hereinafter, referred to as nanobubble-containing liquid) is said to show improved effects of washing, sterilization and deodorizing since nanobubbles manifest longer residence time in a liquid phase than microbubbles (diameter: several micrometers to dozens of micrometers). Various technologies are suggested as a nanobubble generating device for generating nanobubbles in a liquid phase and include, for example, technologies as described below.

Patent document 1 discloses spraying high pressure water in water containing a mixed gas to cause collision against the wall surface of a nanobubble generating device and the like and generating nanobubbles with the aid of its impact.

Patent document 2 discloses allowing a fluid obtained by mixing a gas and a liquid to flow and turn at high speed in a device having a cylindrical structure, to cause generation of turbulence, and shearing the gas by the turbulence, thereby generating nanobubbles.

Patent document 3 discloses applying ultrasonic vibration into a liquid phase containing fine bubbles such as microbubbles and the like, and destroying microbubbles and the like by the vibration, thereby generating nanobubbles.

### PRIOR ART DOCUMENT

### Patent Document

Patent document 1: JP-A No. 2009-195889

Patent document 2: JP-A No. 2008-272719

Patent document 3: JP-A No. 2006-289183

### GENERAL DESCRIPTION OF THE INVENTION

### Problem to be Solved by the Invention

The invention of patent document 1 aims to generate fine bubbles by impact power and the invention of patent document 2 aims to generate fine bubbles by a high speed turning flow containing a gas phase and a liquid phase mixed, respectively, however, there is a problem that the diameter of the resultant bubbles is non-uniform and it is difficult to control the bubble diameter. The invention of patent document 3 generates nanobubbles on the basis of a gas dissolved in a liquid phase, and has a problem that it is difficult to stabilize the degree of supersaturation in a liquid phase after generation of nanobubbles.

It is believed that the inside of bubbles reduced to nano order is under high pressure condition, according to the Young Laplace formula. Under such high pressure condition, a gas contained in nanobubbles is dissolved in the surrounding liquid phase, according to the Henry's law, thus, nanobubbles are said to gradually decrease in size and disappear in due course, lacking in stability in a liquid phase.

Therefore, the technological problem to be solved by the present invention is to provide a nanobubble generating system and a nanobubble generating method in which nanobubbles exist stably in a liquid phase by a very simple constitution and a very simple process.

### Means for Solving Problem

For solving the above-described technological problem, a nanobubble generating system and a nanobubble generating method described below are provided according to the present invention.

That is, a nanobubble generating system according to the present invention is characterized by comprising a generation chamber for accommodating a gas phase part existing in the upper side and a liquid phase part in contact with the lower side of the gas phase part under sealed condition, a supersaturated dissolved liquid generating device for generating supersaturated dissolved liquid in which a gas is dissolved in the liquid phase part under supersaturated condition, and a nanobubble generating device for feeding a pressurized gas to the above-described supersaturated dissolved liquid via through-holes having a nano-sized opening size to generate nanobubbles having a diameter smaller than 1 μm.

In the nanobubble generating system of the present invention, it is preferable that the above-described supersaturated dissolved liquid generating device feeds the pressurized gas to the gas phase part of the above-described generation chamber.

In the nanobubble generating system of the present invention, it is preferable that the above-described supersaturated dissolved liquid generating device feeds the pressurized gas to the liquid phase part of the above-described generation chamber via through-holes.

In the nanobubble generating system of the present invention, it is preferable that the above-described supersaturated dissolved liquid generating device functions also as the above-described nanobubble generating device.

It is preferable that the nanobubble generating system of the present invention is further equipped with a stirring device for stirring the liquid phase part of the above-described generation chamber.

It is preferable that the nanobubble generating system of the present invention is further equipped with a water flow generating device for promoting smooth departure of nanobubbles generated by the above-described nanobubble generating device from the above-described nanobubble generating device.

In the nanobubble generating system of the present invention, it is preferable that the above-described through-holes are mutually separated by a greater distance than 3 times of the opening size.

In the nanobubble generating system of the present invention, it is preferable that the above-described generated nanobubbles are monodispersed.

In an analogous way, a nanobubble generating method according to the present invention is characterized by comprising accommodating a gas phase part existing in the upper side and a liquid phase part in contact with the lower side of the gas phase part in a generation chamber under sealed condition, generating supersaturated dissolved liquid in which a gas is dissolved in the liquid phase part under supersaturated condition, and feeding a pressurized gas to the above-described supersaturated dissolved liquid via through-holes having a nano-sized opening size to generate nanobubbles having a diameter smaller than 1 μm.

### EFFECT OF THE INVENTION

In the generation chamber accommodating a gas phase part and a liquid phase part under sealed condition, supersaturated dissolved liquid in which a gas is dissolved in the liquid phase part under supersaturated condition is generated and nanobubbles are generated in the supersaturated dissolved liquid, thus, there is performed an effect that nanobubbles existing stably in a liquid phase part can be generated by a very simple constitution and a very simple process.

### BRIEF DESCRIPTION OF THE DRAWINGS

FIG. 1 is a view schematically illustrating a nanobubble generating system and a nanobubble generating method according to one embodiment of the present invention;

FIG. 2 is a view showing the particle size distribution of bubbles generated by the nanobubble generating method according to the present invention;

FIG. 3 is a view showing the particle size distribution of bubbles generated by a nanobubble generating method according to a comparative example.

### MODES FOR CARRYING OUT THE INVENTION

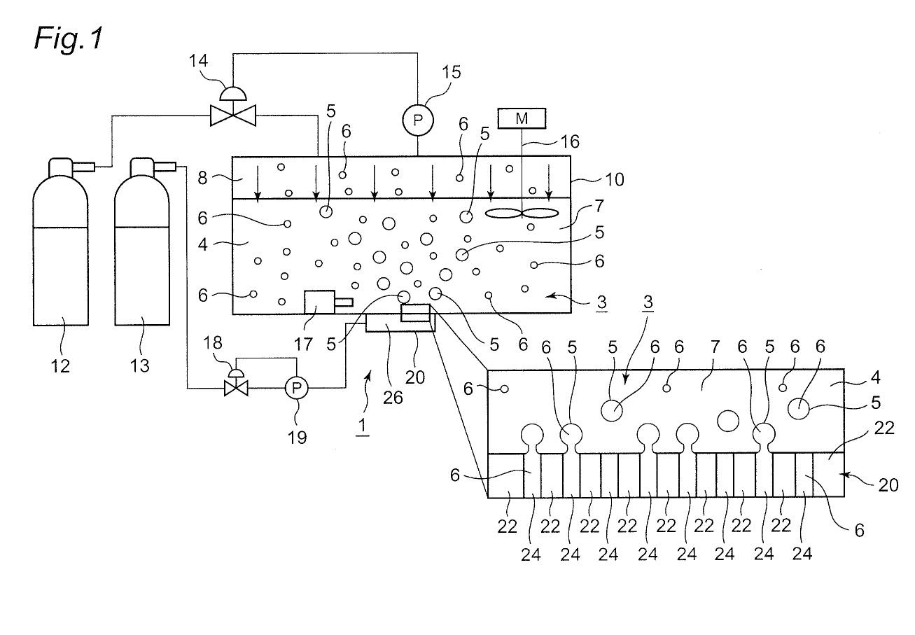

A system 1 for generating nanobubbles 5 and a method for generating nanobubbles 5 according to one embodiment of the present invention will be illustrated in detail below referring to FIG. 1.

The system 1 for generating nanobubbles 5 according to the present invention has a generation chamber 10 keeping sealed condition even under pressurized state, a gas cylinder (pressurized gas feeding device) 12 for feeding a highly pressurized gas 6 to the generation chamber 10, a gas cylinder (nanobubble generating gas feeding device) 13 for feeding the highly pressurized gas 6 to a pore unit 20, and a pore unit (nanobubble generating device) 20 for generating nanobubbles 5, as shown in FIG. 1. The gas cylinder 12 is connected to the generation chamber 10 via a pressure regulation valve 14. The gas cylinder 13 is connected to the pore unit 20 mounted on the bottom wall of the generation chamber 10, via a pressure regulation valve 18 and a manometer 19. The kinds and components of gases 6 fed from these gas cylinders 12 and 13 are identical in the present embodiment.

In the lower side of the generation chamber 10, a liquid phase part 7 filled in smaller quantity than full filling is formed. In the upper side of the generation chamber 10, a gas phase part 8 pressurized at high pressure with a gas 6 fed from the gas cylinder 12 is formed. The liquid phase part 7 and the gas phase part 8 in the generation chamber 10 are in contact via a gas-liquid interface.

On the side of the gas phase part 8 of the generation chamber 10, the pressure regulation valve 14 and a manometer 15 are suitably disposed. That is, between the gas cylinder 12 and the generation chamber 10, the pressure regulation valve 14 for precisely controlling the pressure of the gas 6 feeding from the gas cylinder 12 to the generation chamber 10 is provided. The pressure of the gas phase part 8 in the generation chamber 10 under sealed condition is monitored by the manometer 15. On the side of the gas phase part 8 of the generation chamber 10, a pressure release valve (not graphically-illustrated) is provided for decreasing the applied pressure in the gas phase part 8 gradually down to environmental pressure (atmospheric pressure).

On the liquid phase part 7 of the generation chamber 10, a stirring device 16 and a water flow generating device 17 are suitably disposed. That is, the stirring device 16 is provided for stirring the liquid phase part 7 in the generation chamber 10, so that the degree of supersaturation in supersaturated dissolved liquid 4 becomes as uniform as possible and the generated nanobubbles 5 are dispersed as uniformly as possible in the supersaturated dissolved liquid 4. The water flow generating device 17 is provided near the pore unit 20, for promoting smooth departure of the generated nanobubbles 5 from the pore unit 20. The configuration and the flow rate of the water flow generating device 17 are adjusted, so that microbubbles having larger size than the nanobubbles 5 are not generated by the water flow generating device 17.

Depending on the pressure of the gas 6 fed from the gas cylinder 12, the pressure of the gas phase part 8 varies, the gas 6 constituting the gas phase part 8 is dissolved in the liquid phase part 7 in contact with the gas phase part 8, and the solubility of the gas 6 in the liquid phase part 7 is determined, since the solubility of the gas 6 in the liquid phase part 7 is in proportion to the pressure of the gas 6 according to the Henry's law. Namely, higher the pressure of the gas 6 fed from the gas cylinder 12, larger the solubility of the gas 6 in the liquid phase part 7. In an analogous manner, also the gas 6 contained in nanobubbles 5 generated by the pore unit 20 described later is dissolved in the liquid phase part 7 around the nanobubbles 5, and higher the pressure of the gas 6 in the nanobubbles 5, larger the solubility of the gas 6 in the liquid phase part 7. That is, in proportion to the inner pressure P1 of the gas contained in nanobubbles 5, the gas 6 contained in the nanobubbles 5 is dissolved in the liquid phase part 7 surrounding the nanobubbles 5. Finally, the whole solubility of the liquid phase part 7 in the generation chamber 10 becomes approximately equivalent to the solubility in the liquid phase part 7 surrounding nanobubbles 5.

Next, the pore unit (nanobubble generating device) 20 for generating nanobubbles 5 will be illustrated.

The pore unit 20 having a porous wall 22 is disposed at approximately the center position of the bottom wall surface of the generation chamber 10. The porous wall 22 has a lot of nano-sized fine through-holes 24. The liquid phase part 7 in the generation chamber 10 and a gas phase part 26 in the pore unit 20 are separated via the porous wall 22. The porous wall 22 has a constitution in which the opening size of each through-hole 24 is controlled to prevent pass of the liquid phase part 7 owing to the surface tension of the through-hole 24, while allowing pass of the gas phase part 26 in the pore unit 20 through the through-hole 24. Accordingly, the liquid phase part 7 in the generation chamber 10 does not flow back into the gas phase part 26 in the pore unit 20 through the through-hole 24 of the porous wall 22.

The opening sizes (diameters) of through-holes 24 necessary for generation of nanobubbles 5 having a diameter smaller than 1 μm (1000 nm) include, for example, several nm to several hundred nm, preferably about 10 nm to about 100 nm. It is because when the opening size of a through-hole 24 is approximately less than 10 nm, very large pressure application force is necessary in generating nanobubbles 5 and, thus, handling of the pore unit 20 becomes difficult. It is because, in contrast, when the opening size of the through-hole 24 is approximately larger than 100 nm, there is a possibility of generation of microbubbles having larger size than nano size.

As the porous wall 22, a porous body obtained by anodization or the like is preferable, and it is, for example, a film of anodized aluminum (porous alumina) or anodized silicon (porous silica). An anodized aluminum film is particularly suitable, because of easiness of fabrication of nano-sized through-holes 24. The anodized aluminum film is obtained by anodizing an aluminum plate or an aluminum film formed on other substrate in an acidic electrolyte.

The anodized aluminum film has a geometric structure in which cylindrical through-holes 24 having a radius of several nm to several hundred nm are arranged at an interval of dozens nm to several hundred nm. Bubbles emerging from through-holes 24 are, in general, generated in dilated form having a size larger than the opening sizes of the through-holes 24. When adjacent through-holes 24 come close, adjacent bubbles are mutually integrated to form bubbles of large size (for example, microbubbles) in some cases, even if nanobubbles 5 are generated through each of the through-holes 24. There is a possibility of formation of bubbles having size 4 times larger than the opening size of the through-hole 24, though varying depending on the surface tension of the liquid phase part 7 in contact with the porous wall 22. Therefore, for avoiding mutual interference of adjacent bubbles, it is preferable that the pitch (separated distance) between adjacent through-holes 24 in the porous wall 22 is, for example, larger than 3 times. That is, it is preferable that adjacent apertures are separated at a distance larger than 3 times of the opening size.

As the porous wall 22, use can be made also of Monotran Film obtained by providing a lot of through-holes on a polymer film made of polypropylene, polyethylene terephthalate, and the like. Since the gas 6 does not easily emerge from the through-hole 24 having small opening size due to the influence of wettability of the liquid phase part 7 to the porous wall 22, it is necessary to increase the pressure of the gas phase part 26 in the pore unit 20 and it is necessary to increase also the pressure of the gas 6 fed from the gas cylinder 13.

In nanobubble-containing liquid 3, the differential pressure ΔP between the inner pressure P1 of the gas 6 contained in a nanobubble 5 and the environmental pressure (atmospheric pressure) P2 satisfies the following Young Laplace formula defining the relation between the interfacial tension Y of the liquid phase part 7 against the gas 6 and the diameter D of the nanobubble 5.

ΔP=P1−P2=4_{Y}/D (1)

According to the Young Laplace formula (1) described above, when the diameter D of the nanobubble 5 is smaller, the differential pressure ΔP is larger, and conversely, when the differential pressure ΔP for the nanobubble 5 is larger, the diameter D of the nanobubble 5 becomes smaller. For obtaining the desired diameter D of the nanobubble 5, it may be advantageous that the differential pressure ΔP between the inner pressure P1 of the gas 6 contained in the nanobubble 5 and the environmental pressure P2 is adjusted to a value defined by the Young Laplace formula.

When the differential pressure ΔP for the nanobubble 5 is larger, the diameter D of the nanobubble 5 becomes smaller based on the Young Laplace formula and the solubility of the gas 6 in the liquid phase part 7 surrounding the nanobubble 5 becomes larger based on the Henry's law, and finally, the solubility of the gas 6 for the whole liquid phase part 7 in the generation chamber 10 becomes larger. In contrast, if the solubility of the gas 6 for the whole liquid phase part 7 in the generation chamber 10 is increased and if the solubility of the gas 6 for the liquid phase part 7 surrounding the nanobubble 5 is increased, then, the diameter D of the nanobubble 5 can be decreased. Therefore, if supersaturated state is made in which the gas 6 is dissolved in the liquid phase part 7 with supersaturated solubility wherein the solubility the gas 6 in the liquid phase part 7 is larger than that under usual atmospheric pressure, then, nanobubbles 5 having smaller diameter D can exist stably in the liquid phase part 7.

When the diameter D of the nanobubble 5 is defined, the inner pressure P1 of the gas 6 contained in the nanobubble 5 and the solubility S of the gas 6 in the liquid phase part 7 surrounding the nanobubble 5 are determined, leading to determination of the solubility S of the gas 6 for the whole liquid phase part 7. The solubility S of the gas 6 in the liquid phase part 7 varies depending on the kind of the gas 6. For two cases having different kinds of liquid phase parts 7 and gases 6, the relations of the diameter D of the nanobubble 5, the inner pressure P1 of the gas 6 contained in the nanobubble 5 and the theoretical solubility S of the gas 6 in the liquid phase part 7 were shown in Tables 1 and 2. Table 1 shows results under conditions including pure water having an interfacial tension of 0.07 N/m, 1 atom and 25° C. and Table 2 shows results under conditions including water containing a surfactant having an interfacial tension of 0.027 N/m, 1 atom and 25° C.

TABLE 1

| Diameter of | Inner pressure | Solubility of gas: S (mg/liter) | | | |
|---|---|---|---|---|---|
| nanobubble: | of nanobubble: | | | | carbon |
| D (nm) | P1 (MPa) | nitrogen | oxygen | ozone | dioxide |
| 10 | 28.9 | 5230 | 11600 | 175000 | 425000 |
| 100 | 2.98 | 539 | 1190 | 18000 | 43800 |
| 700 | 0.51 | 93 | 3100 | 3100 | 7530 |
| 1000 | 0.39 | 70 | 2360 | 2360 | 5710 |

TABLE 2

| Diameter of | Inner pressure | Solubility of gas: S (mg/liter) | | | |
|---|---|---|---|---|---|
| nanobubble: | of nanobubble: | | | | carbon |
| D (nm) | P1 (MPa) | nitrogen | oxygen | ozone | dioxide |
| 10 | 10.9 | 1970 | 4370 | 66000 | 160000 |
| 100 | 1.18 | 214 | 473 | 7150 | 17400 |
| 700 | 0.26 | 46 | 102 | 1550 | 3760 |
| 1000 | 0.21 | 38 | 84 | 1270 | 3080 |

According to Table 1, if the diameter D of the nanobubble 5 is defined, for example, as 100 nm in a gas-liquid equilibrium system using pure water as the liquid phase part 7 and oxygen as the gas 6, then, the inner pressure P1 of the nanobubble 5 is 2.98 MPa and the solubility S is 1190 mg/liter. In an analogous manner, according to Table 2, if the diameter D of the nanobubble 5 is defined, for example, as 100 nm in a gas-liquid equilibrium system using surfactant-containing water as the liquid phase part 7 and oxygen as the gas 6, then, the inner pressure P1 of the nanobubble 5 is 1.18 MPa and the solubility S is 473 mg/liter. It may be advantageous, in practical steps, to adopt values approximately 0.5 to 2 times the values of solubility S shown in Tables 1 and 2, for nanobubbles 5 having the desired diameter to exist stably in the supersaturated dissolved liquid 4, since the values of solubility S shown in Tables 1 and 2 are theoretical numerical values determined from the Young Laplace formula and the Henry's law and vary also depending on the interfacial tension.

Under atmospheric pressure (1 atm), the gas 6 is not dissolved in the liquid phase part 7 at solubility not lower than the saturated solubility corresponding to atmospheric pressure. Under a pressurized environment in which the gas 6 is pressurized, however, the gas 6 can be dissolved in the liquid phase part 7 at solubility corresponding to pressure application force, and the gas 6 is dissolved in the liquid phase part 7 at solubility not lower than the saturated solubility under atmospheric pressure. When the pressurized environment is gradually returned to an atmospheric pressure environment, condition in which the gas 6 is dissolved in the liquid phase part 7 at solubility not lower than the saturated solubility, namely, supersaturated state can be produced, and the supersaturated state is relatively stable even under an atmospheric pressure environment.

In the generation chamber 10 a part of which is filled with the liquid phase part 7 and the remaining part of which is filled with the gas phase part 8, such supersaturated state can be produced by 1) pressurizing the gas phase part 8 of the generation chamber 10 with the gas 6 fed from the gas cylinder 12, and/or 2) generating nanobubbles 5 in the liquid phase part 7 of the generation chamber 10, respectively. It is because, in the method 1) of pressurizing the gas phase part 8, the solubility of the gas 6 in the liquid phase part 7 increases based on the Henry's law, since the pressure of the gas phase part 8 is high. It is because, in the method 2) of generating nanobubbles, the solubility of the gas 6 in the liquid phase part 7 increases based on the Henry's law, since, for nanobubbles 5 having small diameter D, the differential pressure ΔP for the gas 6 in the nanobubbles 5 existing in the liquid phase part 7 is high. The liquid phase part 7 under supersaturated state in which the gas 6 is dissolved in the liquid phase part 7 at solubility not lower than the saturated solubility can be called supersaturated dissolved liquid 4.

### EXAMPLE 1

Next, a process for producing nanobubble-containing liquid 3 will be illustrated.

First, the gas 6 is dissolved in the liquid phase part 7 at desired supersaturated solubility not lower than the saturated solubility, by 1) pressurizing the gas phase part 8 of the generation chamber 10 with the gas 6 fed from the gas cylinder 12, and/or 2) generating nanobubbles 5 in the liquid phase part 7 of the generation chamber 10. In this case, it is preferable to stir the liquid phase part 7 by the stirring device 16, so that the degree of supersaturation in the liquid phase part 7 becomes as uniform as possible. Then, the pressure release valve is opened and the pressure of the gas phase part 8 in the generation chamber 10 is gradually lowered down to environmental pressure (atmospheric pressure), to generate the supersaturated dissolved liquid 4. In the supersaturated dissolved liquid 4, the gas 6 is dissolved in the liquid phase part 7 relatively stably at desired supersaturated solubility.

Next, when the gas 6 from the gas cylinder 13 is fed to the pore unit 20, the fed gas 6 is fed into the supersaturated dissolved liquid 4 in the generation chamber 10 via fine through-holes 24. Nanobubbles 5 are formed in the supersaturated dissolved liquid 4 in the generation chamber 10, with the aid of the gas 6 fed from the gas cylinder 13. In this case, it is preferable to form a flow of the supersaturated dissolved liquid 4 toward the pore unit 20 by the water flow generating device 17, so that the generated nanobubbles 5 depart smoothly from the pore unit 20.

Since the supersaturated solubility in the supersaturated dissolved liquid 4 equals the solubility corresponding to the desired diameter of nanobubbles 5, gas-liquid equilibrium state is formed between the gas 6 in the nanobubbles 5 and the supersaturated dissolved liquid 4 existing around the nanobubbles 5, according to the Young Laplace formula and the Henry's law described above. As a result, the nanobubbles 5 having the desired diameter D can exist stably in the supersaturated dissolved liquid 4.

For confirming the stability of the nanobubbles 5 in the supersaturated dissolved liquid 4, the following measurement was carried out.

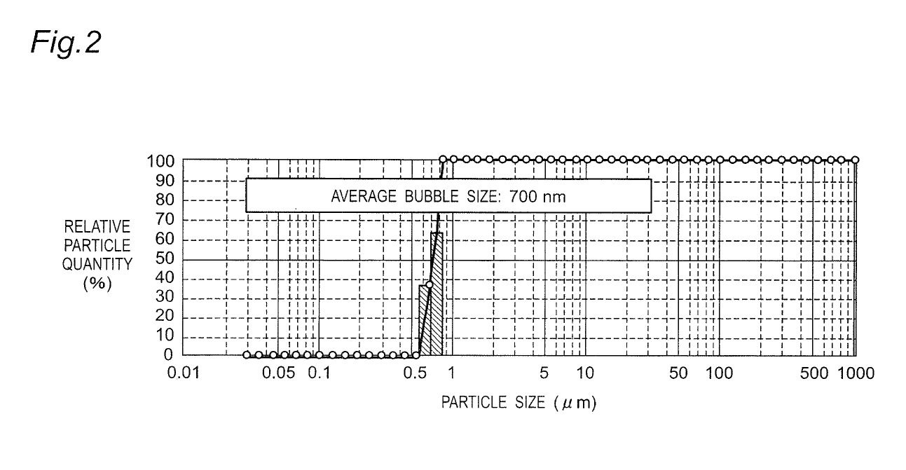

Nanobubble-containing liquid 3 elapsed by 5.1 seconds after generation of the nanobubbles 5 by allowing the supersaturated dissolved liquid 4 to flow in a cylindrical pore film was introduced into a measuring cell of a laser diffraction/scattering particle size distribution analyzer (trade name “SALD-2100”, manufactured by Shimadzu Corporation), and the bubble diameter distribution was measured. The supersaturated dissolved liquid 4 was generated by pressurizing (absolute pressure: about 0.4 MPa) the gas phase part 8 of the generation chamber 10. The nanobubble-containing liquid 3 subjected to measurement shows a gas-liquid equilibrium system using surfactant-containing water as the liquid phase part 7 and oxygen as the gas 6. The measurement results of the resultant bubble diameter distribution are shown in FIG. 2. In calculation of the bubble diameter, the refractive index of bubbles was 1.35 and the average diameter of bubbles was shown as the average size. It was confirmed that the bubbles obtained by the present invention were nanobubbles excellent in monodispersibility and having an average diameter of about 700 nm and existed stably even 5.1 seconds after generation of the nanobubbles, as apparent also from FIG. 2. In this case, the supersaturated solubility of oxygen in surfactant-containing water was about 80 mg/liter.

The same measurement as described above was conducted to confirm the stability of nanobubbles 5 in saturated liquid in which the solubility of the gas 6 equaled saturated solubility, for comparison.

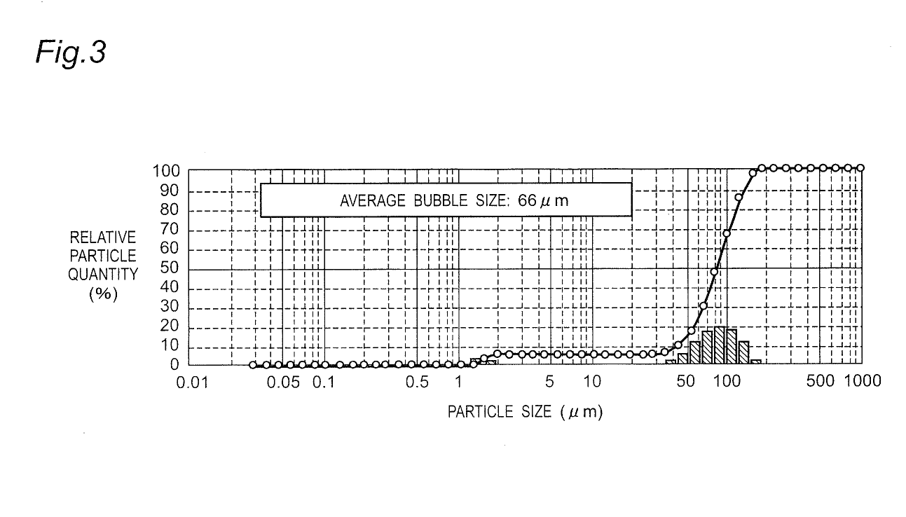

Bubble-containing liquid elapsed by 5.1 seconds after generation of the nanobubbles in saturated liquid was introduced into a measuring cell of a laser diffraction/scattering particle size distribution analyzer (trade name “SALD-2100”, manufactured by Shimadzu Corporation), and the bubble diameter distribution was measured. The bubble-containing liquid subjected to measurement shows a gas-liquid equilibrium system using surfactant-containing water as the liquid phase part 7 and oxygen as the gas 6. The measurement results of the resultant bubble diameter distribution are shown in FIG. 3. In calculation of the bubble diameter, the refractive index of bubbles was 1.35 and the average diameter of bubbles was shown as the average size. The bubbles experimented as a comparative example were broad bubbles having various bubble diameters and microbubbles having an average diameter of about 66 μm, and the stability of nanobubbles was poor, resulting in scarce existence of nanobubbles, as apparent also from FIG. 3. In this case, the solubility of oxygen in surfactant-containing water was about 10 mg/liter.

According to the above-described explanation, when the generating system 1 and the generating method of the present invention are used, nanobubble-containing liquid 3 containing nanobubbles 5 having a diameter smaller than 1 μm (1000 nm) can be produced by appropriately adjusting the supersaturated solubility of the gas 6 in the supersaturated dissolved liquid 4, and/or, the opening size of through-holes 24 of the porous wall 22 in the pore unit 20. Therefore, in the generation chamber 10 accommodating the gas phase part 8 and the liquid phase part 7 under sealed condition, nanobubbles 5 existing stably in the liquid phase part 7 can be generated by a very simple constitution and a very simple process, since the supersaturated dissolved liquid 4 containing the gas 6 dissolved under supersaturated condition in the liquid phase part 7 is generated and nanobubbles 5 are generated in the supersaturated dissolved liquid 4.

In the nanobubble-containing liquid 3 generated by the generating system 1 and generating method of the present invention, nanobubbles 5 exist relatively stably in the liquid phase part 7, thus, the nanobubble-containing liquid 3 is capable of manifesting excellent effects in washing, purification, deodorizing, sterilization, bioactivity and the like and can be utilized in various fields such as electricity, machinery, chemistry, agriculture, forestry and fisheries, remedy and the like.

As the liquid phase part 7 to be used in the nanobubble-containing liquid 3 generated by the generating system 1 and generating method of the present invention, exemplified are water such as pure water, tap water, ion exchanged water, soft water and the like; solutions containing sodium chloride or a surfactant; organic solvents; oils such as gasoline and the like; etc. As the gas 6 to be used in the generated nanobubble-containing liquid 3, exemplified are an oxygen gas, a nitrogen gas, a hydrogen gas, a carbon dioxide gas, an argon gas, an ozone gas, a helium gas; or hydrocarbon gases such as a methane gas and the like; etc.

The above-described embodiment is a so-called batch-mode system in which nanobubbles 5 are generated by the pore unit 20 mounted on the bottom wall of the generation chamber 10. In contrast, a generating system of continuous mode can also be adopted wherein a pore unit containing a porous body and provided outside a generation chamber is connected to the generation chamber via piping and the like, and nanobubble-containing liquid is circulated in the generating system. In such a pore unit, a gas phase space into which a pressurized gas is fed and which is disposed outside the porous body and a liquid phase space in which liquid or the like flows continuously and which is disposed inside the porous body are separated via a cylindrical porous body. As a result, nanobubbles can be generated in nanobubble-containing liquid circulating continuously.

For easy understanding of the present invention, specific constitutions and numerical values are used for explanation, however, these are only examples and dot not limit the technological scope of the present invention. It is apparent for those skilled in the art that various embodiments and varied examples can be constituted in the technological scope of the present invention.

### Explanations of Letters and Numerals

1 nanobubble-containing liquid generating system

3 nanobubble-containing liquid

4 supersaturated dissolved liquid

5 nanobubble

6 gas

7 liquid phase part

8 gas phase part

10 generation chamber

12 gas cylinder (pressurized gas feeding device)

13 gas cylinder (nanobubble generating gas feeding device)

16 stirring device

17 water flow generating device

20 pore unit (nanobubble generating device)

22 porous wall

24 through-hole

1. A nanobubble generating system comprising:
a generation chamber for accommodating a gas phase part existing in the upper side and a liquid phase part in contact with the lower side of the gas phase part under sealed condition,
a supersaturated dissolved liquid generating device for generating supersaturated dissolved liquid in which a gas is dissolved in the liquid phase part under supersaturated condition, and
a nanobubble generating device for feeding a pressurized gas to said supersaturated dissolved liquid via through-holes having a nano-sized opening size to generate nanobubbles having a diameter smaller than 1 μm.

2. The nanobubble generating system according to claim 1, wherein said supersaturated dissolved liquid generating device feeds the pressurized gas to the gas phase part of said generation chamber.

3. The nanobubble generating system according to claim 1, wherein said supersaturated dissolved liquid generating device feeds the pressurized gas to the liquid phase part of said generation chamber via through-holes.

4. The nanobubble generating system according to claim 3, wherein said supersaturated dissolved liquid generating device functions also as said nanobubble generating device.

5. The nanobubble generating system according to claim 1, further equipped with a stirring device for stirring the liquid phase part of said generation chamber.

6. The nanobubble generating system according to claim 1, further equipped with a water flow generating device for promoting smooth departure of nanobubbles generated by said nanobubble generating device from said nanobubble generating device.

7. The nanobubble generating system according to claim 1, wherein said through-holes are mutually separated by a greater distance than 3 times of the opening size.

8. The nanobubble generating system according to claim 1, wherein said generated nanobubbles are monodispersed.

9. A nanobubble generating method comprising:
accommodating a gas phase part existing in the upper side and a liquid phase part in contact with the lower side of the gas phase part in a generation chamber under sealed condition,
generating supersaturated dissolved liquid in which a gas is dissolved in the liquid phase part under supersaturated condition, and
feeding a pressurized gas to said supersaturated dissolved liquid via through-holes having a nano-sized opening size to generate nanobubbles having a diameter smaller than 1 μm.

10. The nanobubble generating method according to claim 9, wherein said supersaturated dissolved liquid is generated by feeding the pressurized gas to the gas phase part of said generation chamber.

11. The nanobubble generating method according to claim 9, wherein said supersaturated dissolved liquid is generated by feeding the pressurized gas to the liquid phase part of said generation chamber via through-holes.

12. The nanobubble generating method according to claim 11, wherein generation of said supersaturated dissolved liquid functions also as generation of said nanobubbles.

13. The nanobubble generating method according to claim 9, further comprising stirring the liquid phase part of said generation chamber.

14. The nanobubble generating method according to claim 9, further comprising generating a water flow for promoting smooth departure of said generated nanobubbles.

15. The nanobubble generating method according to claim 9, wherein said through-holes are mutually separated by a greater distance than 3 times of the opening size.

16. The nanobubble generating method according to claim 9, wherein said generated nanobubbles are monodispersed.
